(19) United States
(12) Patent Application Publication
(10) Pub. No.: US 2015/0373048 A1
(43) Pub. Date: Dec. 24, 2015

(54) Enterprise Mobile Notification Solution

(71) Applicant: Kashif Ali Siddiqui, Karachi (PK)

(72) Inventor: Kashif Ali Siddiqui, Karachi (PK)

(21) Appl. No.: 14/749,510

(22) Filed: Jun. 24, 2015

Related U.S. Application Data
(60) Provisional application No. 62/016,533, filed on Jun. 24, 2014.

(51) Int. Cl. H04L 29/06; H04W 12/04; H04L 12/24

(52) U.S. Cl. CPC H04L 63/166; H04L 41/0686; H04L 67/42; H04L 41/0806; H04L 63/20; H04L 63/0428; H04L 63/06; H04W 12/04; H04L 63/083; H04L 63/0823; H04L 63/10

(57) ABSTRACT

The present invention provides mobile clients that can be easily distributed using any third party MDM (Mobile Device Management) solutions, or mobile app stores. Two operational modes provide only messaging functions, or give more functions to manage and control various processes in the system server. This gives an easy way for Enterprises to manage their license cost by providing advance functions to targeted technical users. The solution works on all the above mentioned platforms and enables an Enterprise to work with heterogeneous mobile devices and platforms. An admin panel on the server software through which an admin can control each and every mobile device, and its access to the information. The present invention provides an easy to define general policy through which rules can be defined for all devices. Similarly, specific rules for individual devices can also be defined, and applied instantaneously.

### CROSS REFERENCE TO RELATED APPLICATIONS

This application claims priority from U.S. Patent Application Ser. No. 62/016,533, entitled “Enterprise Mobile Notification Solution”, filed on Jun. 24, 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to mobile notification systems. More specifically, the present invention relates to mobile notification systems providing real-time messaging services with backup fallback to platform specific push notification services.

### BACKGROUND OF THE INVENTION

The workplace continues to move at an increasingly faster pace requiring real-time response and access, as well as secure text messaging. Smartphones can help bridge the technology gap for mobile employees as well as those that are just away from their desk or need to respond after-hours.

Traditional Mobile Notification services depends heavily on the carrier, and hence often hit by the carrier coverage limitations, and their communication cost. More over these notification solutions provide basic (rudimentary) functions with severe lacking in support for content security, content type, and content size. Also there were no or limited two-way workflow support. Along with that, the communication is not real-time, and often unreliable.

### DEFINITIONS

Unless stated to the contrary, for the purposes of the present disclosure, the following terms shall have the following definitions:

The Advanced Encryption Standard (AES), also referenced as Rijndael (its original name), is a specification for the encryption of electronic data established by the U.S. National Institute of Standards and Technology (NIST) in 2001.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The Apple Push Notification Service (APNs) is a service created by Apple Inc. that was launched together with iOS 3.0 on Jun. 17, 2009. It forwards notifications of third party applications to the Apple devices; such notifications may include badges, sounds or custom text alerts.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

A client is a piece of computer hardware or software that accesses a service made available by a server. The server is often (but not always) on another computer system, in which case the client accesses the service by way of a network. The term applies to programs or devices that are part of a client-server model.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

A gateway is a link between two computer programs or systems such as Internet Forums. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

“HNP” The present invention's communication is based on a proprietary protocol called HNP, short for HipLink Notification Protocol. This protocol is being designed to allow interconnection with clients on heterogenic platforms. The protocol design has special considerations for security, scalability, extensibility, and usability. The HNP protocol uses the TCP/IP as the carrier protocol for its communication. This enables the client apps (including mobile apps) to communicate with the server using any network type whether it is LAN (Ethernet), WLAN (Wi-Fi), carrier data networks (GPRS/Edge, EvDO, HSPA, LTE, etc.). Also the communication is session oriented, and its packets ordering, sequencing, and retransmission is all depends on the TCP layer.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

iOS (originally iPhone OS) is a mobile operating system created and developed by Apple Inc. and distributed exclusively for Apple hardware. It is the operating system that presently powers many of the company's mobile devices, including the iPhone, iPad, and iPod touch.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

An operating system (OS) is software that manages computer hardware and software resources and provides common services for computer programs. The operating system is an essential component of the system software in a computer system. Application programs usually require an operating system to function.

In computer networking, a port is a software construct serving as a communications endpoint in a computer's host operating system. The purpose of ports is to uniquely identify different applications or processes running on a single computer and thereby enable them to share a single physical connection to a packet-switched network like the Internet; they were unnecessary until computers became capable of executing more than one program at the same time. A port is always associated with an IP address of a host and the protocol type of the communication, and thus completes the destination or origination address of a communications session. A port is identified for each address and protocol by a 16-bit number, commonly known as the port number. Specific, well-known port numbers are often used to identify specific applications and services. Of the thousands of enumerated ports, 1024 well-known port numbers are reserved by convention to identify specific service types on a host. The protocols that primarily use ports are the Transport Layer protocols, such as the Transmission Control Protocol (TCP) and the User Datagram Protocol (UDP) of the Internet Protocol Suite. In the client-server model of application architecture, ports are used to provide a multiplexing service on each port number that network clients connect to for service initiation, after which communication is reestablished on another connection-specific port number.

In cryptography, a public key certificate (also known as a digital certificate or identity certificate) is an electronic document used to prove ownership of a public key. The certificate includes information about the key, information about its owner's identity, and the digital signature of an entity that has verified the certificate's contents are correct. If the signature is valid, and the person examining the certificate trusts the signer, then they know they can use that key to communicate with its owner. In a typical public-key infrastructure (PKI) scheme, the signer is a certificate authority (CA), usually a company which charges customers to issue certificates for them. In a web of trust scheme, the signer is either the key's owner (a self-signed certificate) or other users (“endorsements”) whom the person examining the certificate might know and trust. Certificates are an important component of Transport Layer Security (TLS, sometimes called by its older name SSL, Secure Sockets Layer), where they prevent an attacker from impersonating a secure website or other server. They are also used in other important applications, such as email encryption and code signing.

Public-key cryptography, also known as asymmetric cryptography, is a class of cryptographic protocols based on algorithms that require two separate keys, one of which is secret (or private) and one of which is public. Although different, the two parts of this key pair are mathematically linked. The public key is used, for example, to encrypt plaintext or to verify a digital signature; whereas the private key is used for the opposite operation, in these examples to decrypt ciphertext or to create a digital signature. The term “asymmetric” stems from the use of different keys to perform these opposite functions, each the inverse of the other—as contrasted with conventional (“symmetric”) cryptography which relies on the same key to perform both. Public-key algorithms are based on mathematical problems that currently admit no efficient solution and are inherent in certain integer factorization, discrete logarithm, and elliptic curve relationships. It is computationally easy for a user to generate a public and private key-pair and to use it for encryption and decryption. The strength lies in the “impossibility” (computational impracticality) for a properly generated private key to be determined from its corresponding public key. Thus the public key may be published without compromising security. Security depends only on keeping the private key private. Public key algorithms, unlike symmetric key algorithms, do not require a secure for the initial exchange of one (or more) secret keys between the parties.

Push Notification, Push, or server push, describes a style of Internet-based communication where the request for a given transaction is initiated by the publisher or central server. It is contrasted with pull/get, where the request for the transmission of information is initiated by the receiver or client.

A server is a running instance of an application (software) capable of accepting requests from the client and giving responses accordingly. Servers can run on any computer including dedicated computers, which individually are also often referred to as “the server”.

The Secure Hash Algorithm (SHA) is a family of cryptographic hash functions published by the National Institute of Standards and Technology (NIST) as a U.S. Federal Information Processing Standard (FIPS).

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

Transport Layer Security (TLS) and its predecessor, Secure Sockets Layer (SSL), are cryptographic protocols designed to provide communications security over a computer network.

Tokenization, when applied to data security, is the process of substituting a sensitive data element with a non-sensitive equivalent, referred to as a token, that has no extrinsic or exploitable meaning or value. The token is a reference (i.e. identifier) that maps back to the sensitive data through a tokenization system. The mapping from original data to a token uses methods which render tokens infeasible to reverse in the absence of the tokenization system, for example using tokens created from random numbers.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The inventor(s) have developed a suite of mobile applications that provide maximum flexibility and leverage optimum use of today's smartphones. Using inventor(s)'s Enterprise Messaging Applications Users can have a priority view of important alerts, get fully-secure text messages or have capability to send messages and execute actions remotely.

The inventor(s) leverage their proprietary protocol HNP to work on top of TCP over live connections, completely independent of cellular SMS. The applications provide advanced messaging features for encrypted text messages, overriding phone settings for emergency messages, and one click responses in both the system's Inbox and Mobile. As a secure, easy-to manage platform, the present invention improves overall communication throughout the organization, regardless of location.

The present invention provides a cutting edge platform for Enterprises that are quite unique from the other solutions. Firstly the present invention frees the customer from the carrier dependence, and adds support for communication over Internet protocol using Wi-Fi or carrier data networks. Along with it, the present invention provides complete end-to-end security of messages with support for remote administration, and device control. Above all the present invention gives real-time messaging services with backup fallback to platform specific push notification services. The present invention also enables advance messaging workflows which are now becomes the basic needs of today's Enterprises.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the iOS app. created with a provisioning profile enabled with APNS support;

FIG. 2 illustrates how the communication link is protected and secured by TLS protocol;

FIG. 3 provides a list of all the network communications that occurs in the Mobile Notification Solution of the present invention;

FIG. 4 illustrates the overall communication and data flow in the present invention; and

FIG. 5 illustrates the HNP Authentication & session communication starts after TLS successfully initiated.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-user network; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents. The Mobile Notification Solution of the present invention is available for the following platforms: ANDROID MOBILES; ANDROID TABLETS; APPLE'S IPHONES/IPODS; APPLE'S IPAD; MICROSOFT WINDOWS DESKTOP; BLACKBERRY 10 MOBILES.

The same solution works on all the above mentioned platforms and enables an Enterprise to work with heterogeneous mobile devices and platforms.

The present invention provides two operational modes for the mobile app; Basic and Advance. The basic mode provides only messaging functions, whereas the advance mode gives more functions to manage and control various processes in the system server. This gives an easy way for Enterprises to manage their license cost by providing advance functions to targeted technical users.

The present invention provides mobile clients that can be easily distributed using any third party MDM (Mobile Device Management) solutions, or mobile app stores. The apps are tested to work with the today's widely used MDM solutions like MOBILEIRON.

The present invention provides admin panel on the server software through which an admin can control each and every mobile device, and its access to the information. The present invention provides an easy to define general policy through which rules can be defined for all devices. Similarly, specific rules for individual devices can also be defined, and applied instantaneously. More over mobile data can also be erased remotely.

The present invention provides full end-to-end security using the Industry accepted cryptographic algorithms; ie. AES. The end-to-end security means, all communication between the present invention server and the present invention mobile apps is secured, all the messages saved on the devices are secured, and all the messages saved on the devices can be managed with automatic deletion, message expiry, and remote administration.

To ensure message confidentiality, integrity and authenticity, along with security against various attacks the present invention uses the best possible mechanism, Transport Layer Security (TLS) which is recognized as security standard in the enterprise community. TLS, the successor to SSL, offers a robust security protocol meeting IETF standards for connection security. Using TLS, the present invention smartphone apps support a wide variety of bit-rate encryption options that include 128, 196 and 256-bit AES encryption standards configurable by the administrator.

One of the more interesting features the present invention has developed by using this standard is a “single session” handshake process. By using this method, the TLS encryption key is constantly changing on each communication session between the system server and the mobile device.

This short “time to live” makes cracking the encryption extremely difficult as the key is constantly regenerating with each communication transaction. The security features apply to all phases of message delivery both messages sent to the phone and responses back.

One of the most essential aspects of the BYOD model is to remotely manage and control the data inside the employees (mobile consumer) devices. The present invention's solution provides an easy to administer, and use features to manage and control consumer's device access to corporate data both on server and on device (local).

The following actions are available to Administrators from the present invention GUI: push application settings remotely from the present invention to the device. Push application capabilities and permissions remotely from the present invention to the device. Delete all or selected data stored in the device application. Lock out access to the present invention. Define a general policy for general authorities and application settings applied to all devices.

The present invention Enterprise Mobile Notification Solution supports several advance workflows that are the need of today's organizations to carry out most of the operations. Besides the simple messaging workflow, the present invention also provides support for the following: Two-Way communication with canned response choices, Escalation messaging, Confidential messaging, Schedule messaging, Broadcasting to all, and On-Duty messaging.

Besides that, the present invention support functions to allow users to efficiently browse contact directory stored in the present invention server, and import contacts to the local favorites list. Confirm or refuse a received message to let know about their availability for the task/job. Respond to a message to let know about their opinion and choice. Forward to other users to spread the word with least efforts. Receive send message replies with recipient's opinions and choices. Send and receive media attachments with messages to share images, audios, video, office contents, etc. Send and receive location with the message to share your or see others location, for easy tracking Send offline messages to users not available.

The present invention Enterprise Mobile Notification Solution is HIPAA (Health Insurance Portability and Accountability Act) compliant, and as per requirements, provides: Confidential data (e.g. PHI) protection in activity logs and audit trails. End-to-end secure communication between the present invention server and mobile app with AES encryption algorithm using TLS. Device level data protection with AES encryption algorithm (with 256 bit keys) to protect messages and received media content. Secure messaging workflow to enforce messaging of confidential data to only secure users, and prevent messaging to insecure users. Mobile app security to prevent access to information (messages and media content) to unintended users. Remote administration to manage and control mobile app access, and its dependent data. Ability to remove (all or selected) data on the device from remote admin console. Ability to disable mobile app from remote admin console.

The present invention Enterprise Mobile Notification Solution support messaging in (close to) real-time, where messages can be received within one second time interval after dispatch. Also all the messaging workflows are designed to be 100% deterministic, letting know the dispatcher immediately regarding the message delivery status whether it is succeeded, failed, or put on hold for later delivery. In the case of later delivery, the messages are sent (as offline messages) when the recipient gets online.

Besides that the mobile platform specific Push Notification solution can also be configured in the present invention to dispatch new message alerts to offline users, gaining their attention to come online. Right now as of this writing, the present invention only supports Apple's APNS (Apple Push Notification Service) for their iOS devices.

The present invention's mobile apps support always online methodology for the mobile users. Hence the apps are designed to always keep the user online for easy access to new messages in real-time. The Android app has special capability to start automatically on device reboots. The apps and their processes are design to put least amount of contribution to the device battery drain. The iPhone app is tested to give an average battery drain within 2% per hour, whereas Android app gives 3% per hour with normal operations.

The present invention server provides full audit trail for all of its communication. Any message can be trace and its dispatch status can be tracked from a single easy to follow reports panel. The Mobile app provides details reporting for each message which includes: Delivery report on message received at the mobile device. Message read report, when the user actually reads a message. Message 2way response status, when the user sends his choice/response to a message. Message confirmation/rejection status, when the user actually confirms or refuses a message.

When a message first arrives, a delivery receipt is sent back to the sender. Message recipients have the ability to actively acknowledge or ignore the message, which is then also transmitted back to the sender. In addition to acknowledgement, users can respond to a message using free-form text or templates. Responses are kept with the original message in system log files for continuity purposes.

Administrators also require a full audit trail, including the ability to run reports on the timing of message delivery and how quickly read receipts were returned from each user's smartphone. This ensures messages are read in a timely fashion and eliminates complaints from users that they didn't receive a message.

The server also provides detailed activity logs for each of its processes from where admin can actually obtains the logs entries of all the workflows and processes done in that module, and can get information and data on activities.

Key Features of the present invention Mobile include: Private inbox for all the messages send from the present invention. Separates critical messages from less important emails and text messages. Secure delivery of messages and responses. Automatic delivery receipts for messages. Active acknowledgement of message and free-form text response. Directory look-up and user authentication. Ability to initiate messages to other users from a device running the present invention Mobile app. Remote application wipe and administration. Leverages cellular and Wi-Fi networks. Supports a variety of devices to accommodate hospital-employed and independent physicians. Real-time messaging for online users, with support for offline messages. New message alerts for offline users using platform specific push notifications services. Full personalization of ring tones for message severity levels, along with other display settings. Persistent alerting for critical and emergency level message. Lock screen notification when phone is in standby mode. Silent notification on status bar for normal (least severe) messages. Multiple file attachment support (all formats). One click callback to numbers in the message body. One click text to numbers in the message body. One click to open URLs embedded in the message body in a browser. Ability to hear message and canned response choices. Ability to see location attached to messages. Ability to define message expiry. Ability to compose message by voice. Ability to define auto delete configuration to automatically delete old messages after N days.

The present invention Enterprise Mobile Notification solution only requires five (5) steps of configuration to become quickly operational. These steps are: Configuring the present invention server; Configuring mobile users; Installing client; Registering (Activating) client; and Login to the present invention server.

In STEP#1: Configuring the present invention server, admin requires to setup HNP manager, HNP carriers and HNP messengers. After this step, solution will be ready to get connections from mobile clients, and become able to send messages to these clients.

In step#2: Configuring mobile users, mobile users are defined in the present invention server contacts database. Each mobile user can be associated with a the present invention server user to grant extra authorities for advance features.

In Step#3: Installing client, the present invention mobile app on the mobile device; smartphone, tablet, or any supported media device. The installation can be over-the-air (OTA) using any MDM solution. Or it can be a manual distribution process involving install the app binary by each mobile user.

After installation, in Step#4: Registering (Activating) client, the app is required to once get registered with the present invention server. This is a onetime process in which the app gets activated at the present invention server.

After registering the app, in Step#5: Login to the present invention server, the user will be require to log into server. The login can be configured as automatic procedure made every time on app startup. Hence in order to get messages, the app is required to have a working session with the present invention server.

In step#6: [optional] Configuring Mobile clients, Mobile user can make various settings in their app from display configuration, to alerting configuration to security setup. The most important ones are setting up the app master password to protect app access to unauthorized or unintended users.

In step#7: [optional] Defining access privileges, and client settings, the present invention server can be configured to define mobile user permissions and/or app settings at the server side. These permissions and/or settings if defined are enforced on the mobile app. Furthermore, admin can setup general policy for mobile access authorities and app settings for all the mobile users.

Many organizations are undertaking a long-term approach to replacing a portion of their pagers. A lot of hospitals still need to use pagers for certain staff members, but they also need to be able to message to smartphones for physicians and others. This means supporting a variety of communication devices for the foreseeable future. The benefit of this approach is that some staff members can consolidate devices using smartphones while others may continue to use pagers. the present invention Mobile enables users to do what makes sense based on staff and messaging requirements.

In another embodiment, the present invention follows a simple client-server model. In which the server provides the service, and the clients that can be mobile apps on ANDROID, IOS OR BB10, or a desktop app on WINS platform consumes the service to receive messages.

The present invention's communication is based on a proprietary protocol called HNP, short for HipLink Notification Protocol. This protocol is being designed to allow interconnection with clients on heterogenic platforms. The protocol design has special considerations for security, scalability, extensibility, and usability.

The HNP protocol uses the TCP/IP as the carrier protocol for its communication. This enables the client apps (including mobile apps) to communicate with the server using any network type whether it is LAN (Ethernet), WLAN (Wi-Fi), carrier data networks (GPRS/Edge, EvDO, HSPA, LTE, etc.). Also the communication is session oriented, and its packets ordering, sequencing, and retransmission is all depends on the TCP layer.

The present invention uses the TLS (Transport Layer Security) protocol to implement CIA in the communication. Hence all the communication is in encrypted form, with proper message checksums to ensure message integrity, along with digital signatures to authenticate the server side.

The present invention also integrates with the platform specific push notification services, to push alerts to the offline user regarding new messages waiting in the queue. This communication follows a different workflow, and it is often goes through the notification service gateways that contacts the mobile device by its own ways, and route the push notifications to the device. Currently the present invention only supports integration with APNS for iOS client apps.

The Enterprise Mobile Notification Solution has several design attributes in which the most essential are regarding communication and security aspects.

The present invention is based on a platform neutral communication mechanism, or protocol, that enables communication to all types of mobile and desktop platform clients. There is no functional distinctions at the sever side for the receiver device whether it is BLACKBERRY, ANDROID, IPHONE or a desktop client. Hence this enables solution to support environments with heterogeneous platforms.

The present invention support of Wi-Fi-enabled devices has never been easier than with the smartphone apps. The user can set his smartphone for Wi-Fi communication to the server when he is in the office, and the system server will automatically switch between his carrier's data network and the Wi-Fi network when in range.

The mobile apps are designed to give more preference to Wi-Fi, and automatically switch from carrier data network to Wi-Fi, when the device enters a Wi-Fi domain.

The present invention requires each client maintains a persistent connection with the system server. The persistent connection allows real-time messaging, along with availability and presence information. The mobile app uses the specialized developed mechanism to manage and maintain this persistent connection. The mobile app are designed to reconnect automatically when the existing one breaks, or when network coverage changes from Wi-Fi to carrier data network or vice versa.

The mechanism provides real-time or close to real-time notification with messaging failures identified at the earliest. There is no queuing mechanisms in the communication path once the message is dispatched.

The present invention provides deterministic messaging service, with clear and on time delivery and message read reports. The reliability is further enhanced with the inclusion of support for offline messaging which is configurable. With offline messaging support disabled, users can define backup workflows to continue messaging to offline users using other protocols.

The present invention provides security at the transport layer, making all the communication between system server and mobile clients engulfed (blanket) in a secure transmission channel. This channel acts as a secure tunnel between server and each mobile client, whereby all the communication happens within it. This not only makes messaging secure, but all the other communication regarding signaling, file transfer, etc also becomes secure.

The secure communication layer is TLS based, and it is established after proper authentication procedure. This mechanism provides security against replay and other common attacks.

The mechanism enables complex messaging workflows which are nowadays required in everyday operations in an organization. It allows the system and mobile clients to send canned response choices with the notifications and ability to enable the user to select one or more choices and send them immediately back to the system.

The present invention supports messaging with attachments. The attachments are sent separately from the message, but shown in association with the message on the mobile app. The attachments can be of any format from media, office or other category of files. The file transfer support is provided in two forms; in-band 409, main communication 409, and out-of-band 408.

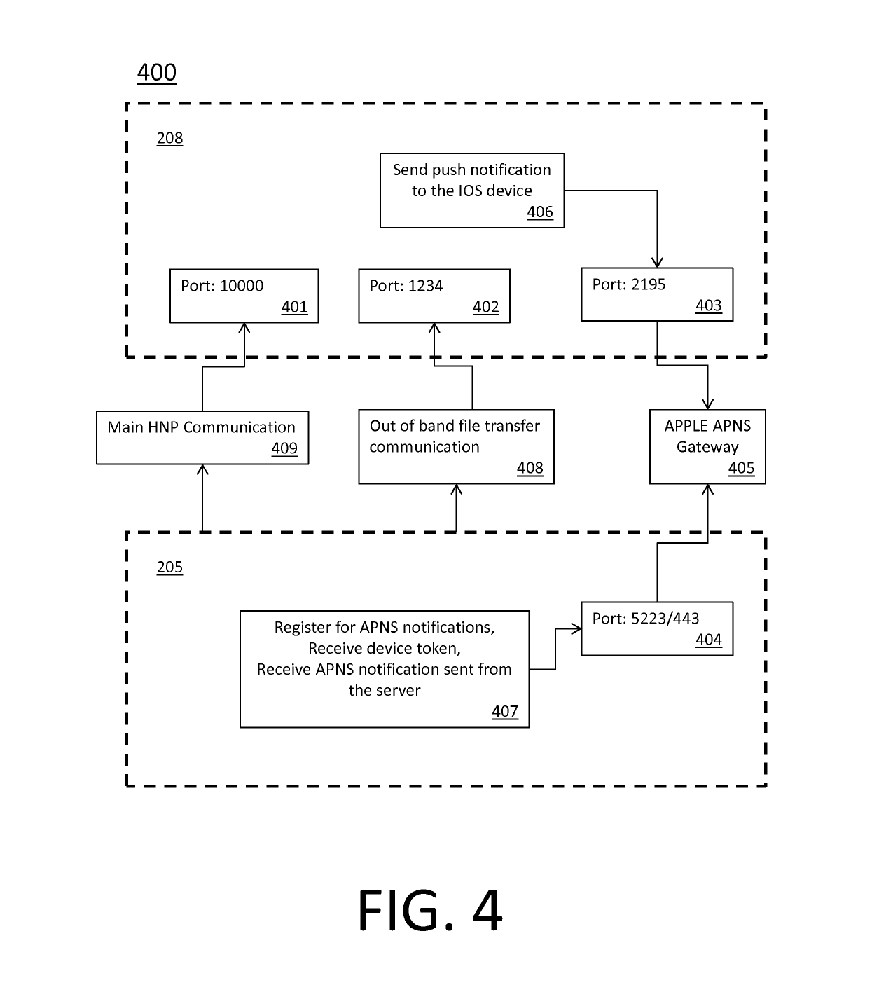

In the former case, the files are transferred using the existing connection between the server and the mobile app. Whereas in the out-of-band 408, a new connection is established by the mobile app to a separate port at server, shown in FIG. 4 a port 1234 402, and file is transferred independently of the primary connection. The out-of-band transfer 408 is faster than the in-band 409, but requires a second port, shown as port 1234 402 in FIG. 4, to be open at the server side 208.

The Enterprise Mobile Notification Solution provides full end-to-end security using the Industry accepted cryptographic algorithms; ie. AES. The end-to-end security means, All communication between the system server and the HipLink mobile apps is secured, All the messages saved on the devices are secured, and All the messages saved on the devices can be managed with automatic deletion, message expiry, and remote administration.

To ensure message confidentiality, integrity and authenticity, along with security against various attacks the system uses the best possible mechanism, Transport Layer Security (TLS) which is recognized as security standard in the enterprise community. TLS, the successor to SSL, offers a robust security protocol meeting IETF standards for connection security. Using TLS, the system k smartphone apps support a wide variety of bit-rate encryption options that include 128, 196 and 256-bit AES encryption standards configurable by the administrator.

One of the more interesting features the system has developed by using this standard is a “single session” handshake process. By using this method, the TLS encryption key is constantly changing on each communication session between the system server and the mobile device.

This short “time to live” makes cracking the encryption extremely difficult as the key is constantly regenerating with each communication transaction. The security features apply to all phases of message delivery both messages sent to the phone and responses back.

The Enterprise Mobile Notification Solution support real-time messaging, where messages can be received within one second time interval after dispatch. Also all the messaging workflows are designed to be 100% deterministic, letting know the dispatcher immediately regarding the message delivery status whether it is succeeded, failed, or put on hold for later delivery. In the case of later delivery, the messages are sent (as offline messages) when the recipients gets online.

The present invention also support integration with mobile platform specific Push Notification services to dispatch new message alerts to offline users, gaining their attention to come online. Right now as of this writing, the present invention only supports Apple's APNS (Apple Push Notification Service) for the iOS devices users.

The mobile apps implement always online methodology for the mobile users. Hence the apps are designed to always keep the user online for easy access to new messages in real-time. The Android app has special capability to start automatically on device reboots. The apps and their processes are design to put least amount of contribution to the device battery drain. The iPhone app is tested to give an average battery drain within 2% per hour, whereas Android app gives within 3% per hour with normal operations.

The APPLE Push Notification Service is a service created by Apple Inc. that was launched together with iOS 3.0 on Jun. 17, 2009. It uses push technology through a constantly open IP connection to forward notifications from the servers of third party applications to the Apple devices; such notifications may include badges, sounds or custom text alerts. Due to limitation in message size, reliability, and security, one cannot send actual data to the iOS device. Hence APNS is only use to let know iOS users regarding new items that need to be processed or fetched by the iOS app.

The APNS support integration requires certain artifacts in order to enable server software to send push notifications to the iOS devices. These are: Define App ID; A SSL Certificate for the server product, and The private key of the SSL certificate.

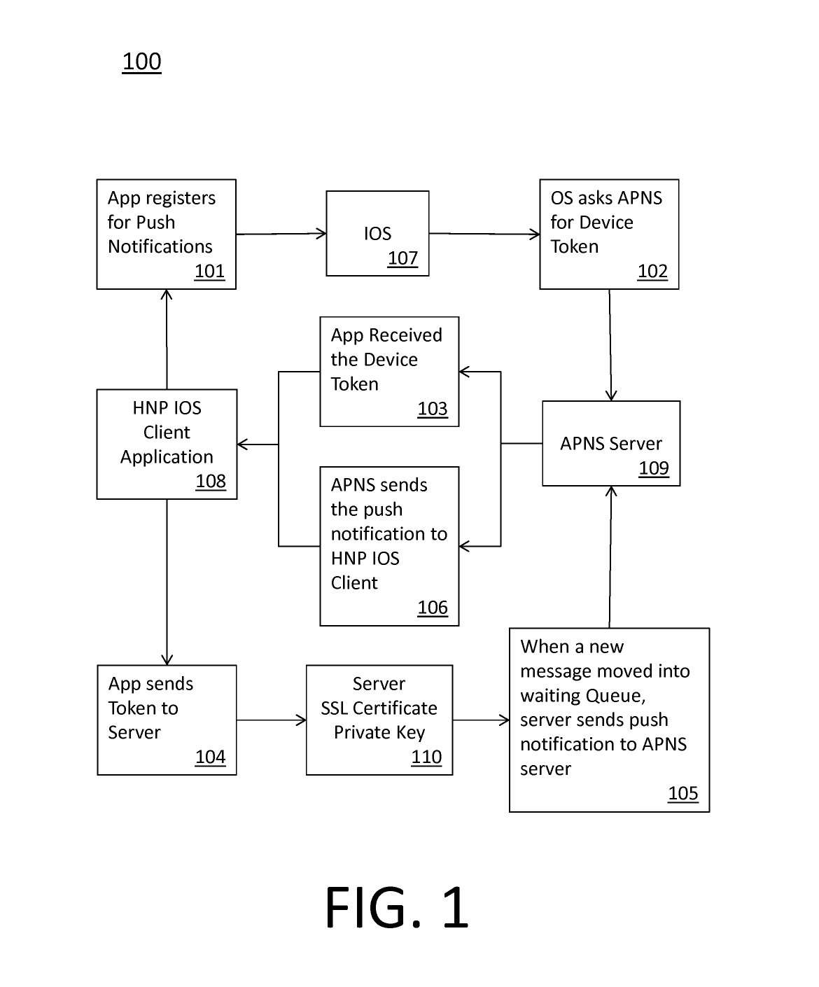

Besides that above, a new key pair may be required, with private key saved in a separate file and public key as a certificate request (.CSR) file. The certificate request is then send to the Apple to get it signed and sealed. Then an app ID is required to be registered at the Apple's iOS developer portal for the iOS app. After that, the SSL certificate will becomes available to download from the provisioning profile panel. This SSL certificate and the private key is then use in the system server to configure integration with APNS gateway 100 as shown in FIG. 1.

Now referring to FIG. 1, the iOS app 107 is created with a provisioning profile enabled with APNS support 101. The iOS app registers for APNS alerts with the APNS gateways by submitting a client application 108, asking for a device token 102, and the receiving its device-token 103. The iOS app sends its token to system server 104. The system server 109 must be configured with APNS SSL Certificate and its associated private key 110. The system server, when a new message moved into waiting Queue, server sends push notification to APNS server 105, connects to APNS gateway 109 using SSL/TLS sockets, and dispatches the alert to the APNS Server 109. The APNS server 109 sends the alert to the iOS device 106.

The Enterprise Mobile Notification Solution is based on a simple client-server model. The system server opens up the service (HNP) server port, whereas the clients that can be of Android, iOS, BB10, or Win Desktop connects to that server port to establish the communication link. Besides that the system can also be configured for a separate server port for file transfer, which is being used to send message attachments to the target recipient mobile app. If system server is configured for APNS, then it will be making connections to the APNS gateway on a fixed port 2195 to send push notifications. Each iOS devices (IPHONE, IPOD and IPAD) will make connections to the APNS gateway on either port 5223 or 443 (if unable to connect on 5223) to register themselves for the APNS service, and to get new notifications.

This is the main primary communication link. This is the basic requirement for the Mobile Notification Solution to work. The system server will open up a HNP service server port. All the client apps (including mobile apps) will connect to this port. This port is completely configurable, and can be set or changed from the HNP configuration panel.

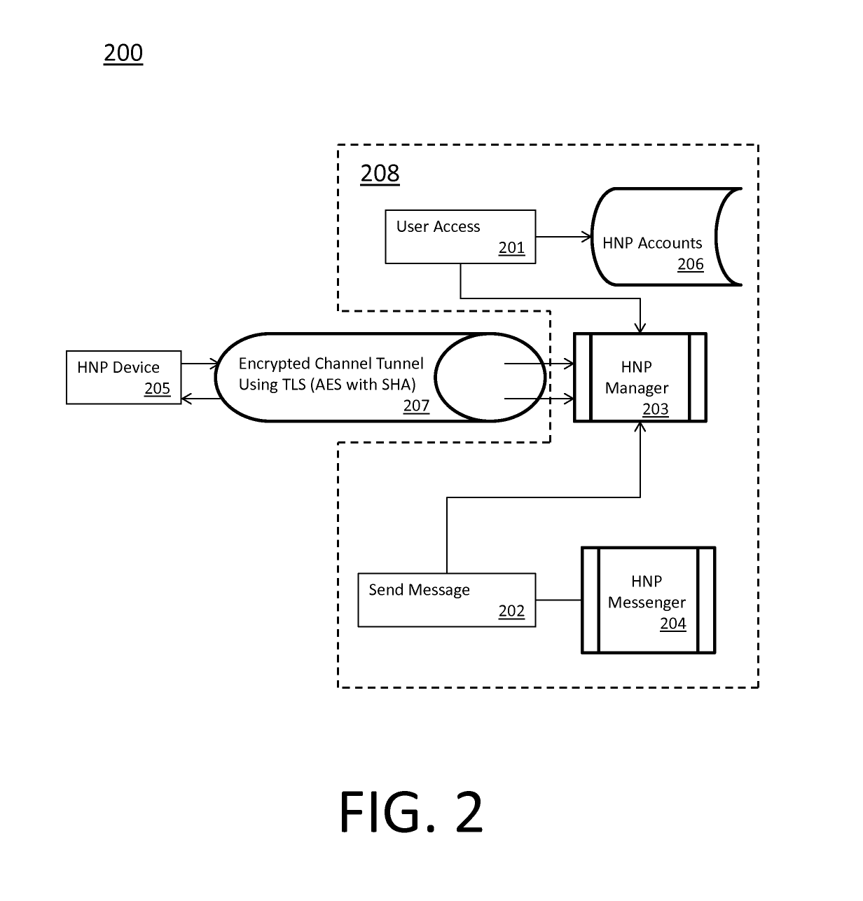

Now referring to FIG. 2, this communication link is protected and secured by TLS protocol 200. As per the TLS requirement, the server 208 must be configured with a server certificate and its associated private key. The TLS will create a secure tunnel 207 between the server 208 and the client device 205, and all the communication regarding messaging, reporting, and other requests, and their responses are sent through this tunnel 207.

The server 208 is further comprised of an HNP manager 203 which provides user access 201 to the accounts 206. The manager 203 also enables the messenger module 204 to send messages 202 through the tunnel 207 secure to client devices 205.

File transfer communication is a secondary communication link that is required only for transferring files that are attached with the message. However as discussed above, the present invention allows two type of transfer mechanisms, and this separate communication is only required when out-of-band mechanism 408 is selected. The server port is defined in the system's messenger, and can be changed to any value as per requirement.

When any client app receives a message with attachment(s) that requests to pull the files using out-of-band mechanism 408, then the server port is also provided, and the client app then initiates the connection to that port, and receives the files in encrypted form. The encryption keys are sent separately with message in the main HNP communication.

Sending APNS push notification is only required when server is configured for APNS support. When a message is sent to an offline iOS device user, the server dispatches a notification through APNS to the iOS device to let know about the new message waiting in server. This is done by connecting to either: gateway.sandbox.push.apple.com, or gateway.push.apple.com on port 2195 403. If the certificate type is development, then #1 is used, otherwise (in case of production) #2 address is used. The connection is secured using SSLv3, in which server uses the configured APNS SSL certificate and private key to also authenticate itself as client to the APNS gateway. After establishing the secure connection, the push notification is sent to the APNS gateway 405 in a binary format, along with the device token already communicated to the server by the device at login.

Each iOS device running the mobile app of the present invention will be communicating with the APNS gateway server 405 on port 5223 404 (or 443 if 5223 is blocked). Each client will maintain a single persistent connection with the APNS gateway. After establishing the connection, first the app registers itself for the APNS notifications, and gets its device token 407. Secondly on the same connection, it waits for the push notifications. On push notification from system server 406, the APNS gateway 405 forwards the notification object to the device over this connection.

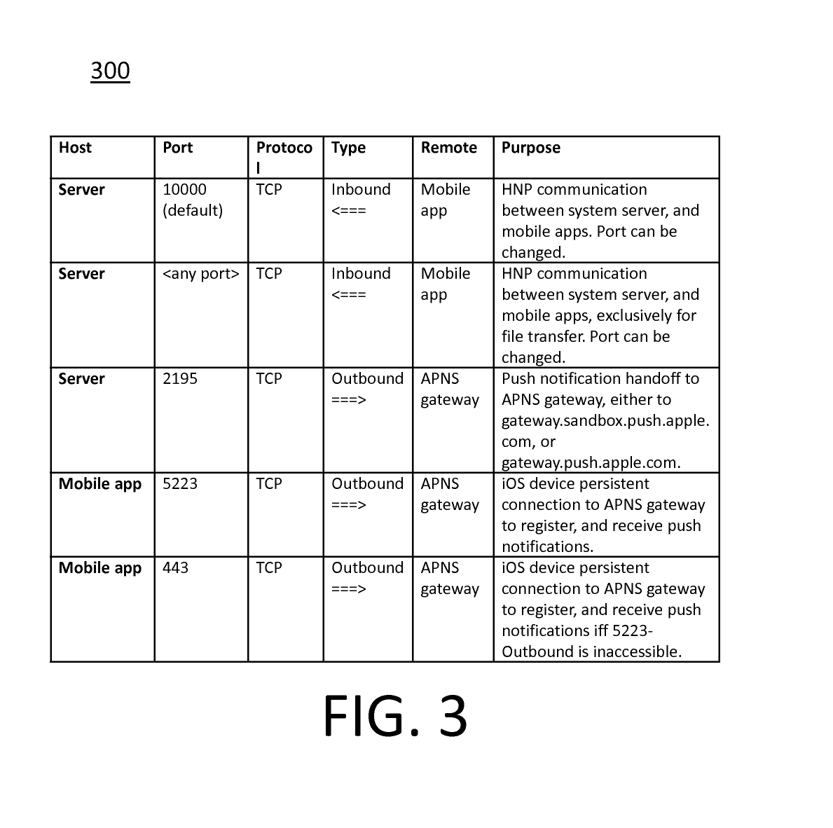

The table 300 of FIG. 3 provides a list of all the network communications that occurs in the Mobile Notification Solution of the present invention. This information can be used to define network firewall rules.

Now referring to FIG. 4, the overall communication and data flow in the present invention is illustrated. The arrow shows the connection initiation direction, whereas data flow will be bi-direction in each of the communication flow. The communication flow engaging the APNS gateway 405 is only applicable for iOS HNP clients.

HNP communication is the primary link between the system server 208 and the client apps. 205. The client app 205 makes a permanent connection to the server 208 using a main HNP communication connection 409 through port 10000 401, and tries to keep it alive for the life of the app's process.

The TLS (Transport Layer Security) connection is made over TCP, and after successful connection, TLS is started immediately. First the server sends its public key (in its server certificate) and client uses it to establish the initial secure connection. The TLS protocol then does the handshake procedure in which cipher capabilities are negotiated, and a shared secret key is established. After that the newly created key is used to secure the following session.

The shared key has an expiration time, and when it expires, it enforces both sides to go through the key creation procedure again. This is done so as to ensure the session stays protected, and if a key is compromised, then it gets changed with a new one soon. Also it helps to protect against replay attacks, and man-in-the-middle attacks.

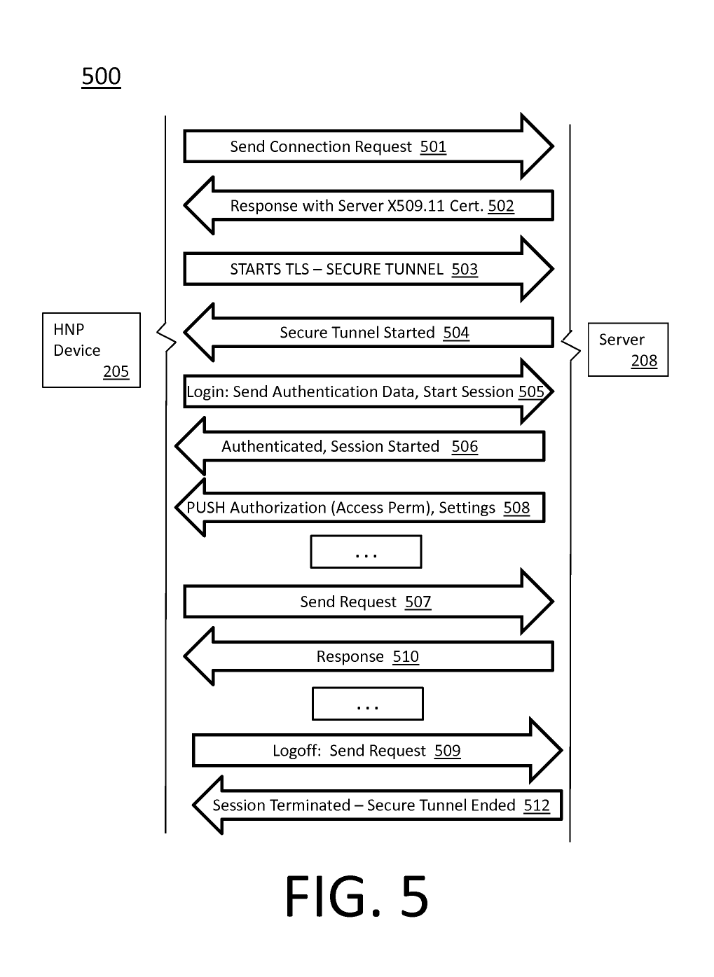

Now referring to FIG. 5, the HNP Authentication & session communication 500 starts after TLS is successfully initiated 503 in response to the initial connection request 501 from the device 205 to the server 208 and the server responding with a certificate 502, creating the secure tunnel 503 and starting secure tunnel communications 504. The first process is the user authentication 505. In this process, the user ID, password, and activation key is sent to the server (in secure tunnel 504). The server 208 authenticates the user, checks its activation, and then responds with user permissions (access privileges) and settings (optional). The permissions further disables app functions (leaving others as enabled), whereas settings changes the usage behavior. After that, the HNP session gets started 506.

Once the HNP operations session gets started 506, then client app on the device 205 can send any request 507 to execute operation at server 208. Also if the server 208 has a message for the device 205, then the same HNP connection is used, and the server pushes the message to the device 508.

Besides receiving messages 508 in this session 500, client can send requests 507 to: query for contacts, send a message to other contacts, query a sent message status, confirm/reject a message, log out of the session, etc. to which the server 208 can send response 510.

The HNP Session Lifecycle 500 will remain active as long as the device 205 has some form of data network to stay connected, the user does not logoff explicitly, and the client app is kept running (either in background or foreground).

At any time the user can send a logoff request 509 from the device to the server. The sever will then terminate the session and secure tunnel 512.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In alternative embodiments, the method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for providing an enterprise mobile notification solution recorded on computer-readable medium and capable of execution by a computer, said method comprising the steps of:
configuring a server;
configuring mobile users devices;
installing the client app. on one or more mobile user devices;
after installation, registering and activating client, the app is required to once get registered with the server;
sending an admin control panel from the server to a user device;
displaying an admin control panel on a mobile device using the client;
registering and activating the client;
requiring logging-in to the server is required after registering the app;
defining access privileges, and client settings. logging-in to the system server;
providing full end-to-end security using cryptographic algorithms;
using Transport Layer Security (TLS);
providing a single session handshake process wherein the TLS encryption key is constantly changing on each communication session between the system server and the mobile device; and
enabling all the messages saved on the devices to be managed with automatic deletion, message expiry, and remote administration.

2. The method of claim 1, further comprising the steps of providing client access to the server for remotely removing data; and
define general policy by the server through which rules can be defined for all devices;
defining specific rules for individual devices; and
applying the rules instantaneously to individual client devices.

3. The method of claim 1, wherein
configuring the server, an admin is required to setup an HNP manager, one or more HNP carriers, and an HNP messenger; and
after this step, a solution will be ready to get connections from mobile clients, and become able to send messages to these clients.

4. The method of claim 1, wherein
configuring mobile users, mobile users are defined in the server contacts database; and
each mobile user can be associated with a server user to grant extra authorities for advance features.

5. The method of claim 1, wherein when installing the client mobile app on the mobile device;
smartphone, tablet, or any supported media device,
the installation can be over-the-air (OTA) using any MDM (Mobile Device Management) solution; or
the installation can be a manual distribution process involving install the app binary by each mobile user.

6. The method of claim 1, wherein the login can be configured as automatic procedure made every time on app startup.

7. The method of claim 1, further comprising the steps of
configuring mobile clients; and
providing a mobile user with various settings in their app from display configuration, to alerting configuration to security setup.

8. The method of claim 1, wherein
the present invention server can be configured to define mobile user permissions and/or app settings at the server side;
these permissions and/or settings if defined are enforced on the mobile app.; and
an admin can setup general policy for mobile access authorities and app settings for all the mobile users.

9. The method of claim 1, further comprising a five step configuration process comprising the steps of
a. configuring the present invention server;
b. configuring mobile users;
c. installing a client;
d. registering (Activating) the client; and
e. logging in to the server.

10. The method of claim 9, wherein
in step a, configuring the present invention server, an admin is required to setup the HNP manager, the HNP carriers and the HNP messengers; and
a solution will be generated and ready to receive connections from mobile clients, and become able to send messages to these clients.

11. The method of claim 9, wherein
in step b, configuring mobile users, mobile users are defined in a server contacts database; and
each mobile user can be associated with a server user to grant extra authorities for advance features.

12. The method of claim 9, wherein
in step c, installing client, the present invention mobile app on the mobile device;
smartphone, tablet, or any supported media device the installation can be over-the-air (OTA) using any MDM solution, or it can be a manual distribution process involving install the app binary by each mobile user.

13. The method of claim 9, wherein
in step d, after installation, registering (Activating) client, the app is required to once get registered with the server.

14. The method of claim 9, wherein
in step e, after registering the app, logging in to the server, the user will be require to log into server;
the login can be configured as automatic procedure made every time on app startup.

15. The method of claim 9, further comprising the steps of
configuring mobile clients, wherein a mobile user can make various settings in their app from display configuration, to alerting configuration to security setup.

16. The method of claim 9, further comprising the steps of
defining access privileges, and client settings, the server can be configured to define mobile user permissions and/or app settings at the server side;
these permissions and/or settings if defined are enforced on the mobile app.; and
an admin can setup general policy for mobile access authorities and app settings for all the mobile users.

17. A method for providing an enterprise mobile notification solution recorded on computer-readable medium and capable of execution by a computer, said method comprising the steps of:
creating an iOS app 107 with a provisioning profile enabled with APNS support'
the iOS app registers for APNS alerts with the APNS gateways by
submitting a client application, a
asking for a device token 1, and
receiving its device-token,
the iOS app sends its token to system server;
the system server must be configured with APNS SSL Certificate and its associated private key;
the system server, when a new message is moved into waiting Queue,
sends push notification to the APNS server,
connects to APNS gateway using SSL/TLS sockets, and
dispatches the alert to the APNS Server
the APNS server sends the alert to the iOS device;
system server opens up the service (HNP) server port, and the clients connects to that server port to establish the communication link;
this port is completely configurable, and can be set or changed from the HNP configuration panel;
the port is configured for a separate server port for file transfer, which is being used to send message attachments to the target recipient mobile app.

18. The method of claim 17, wherein
the communication link is protected and secured by TLS protocol;
the server 208 must be configured with a server certificate and its associated private key;
the TLS will create a secure tunnel between the server and the client device; and
all the communication regarding messaging, reporting, and other requests, and their responses are sent through this tunnel;
the server is further comprised of an HNP manager which provides user access to the accounts;
the server is further comprised of a manager that enables a messenger module to send messages through the tunnel securely to client devices;
when any client app receives a message with attachment(s) that requests to pull the files using out-of-band mechanism, then the server port is also provided;
the client app then initiates the connection to that port, and receives the files in encrypted form;
the he encryption keys are sent separately with a message in the main HNP communication.

19. The method of claim 18, wherein
HNP communication is the primary link between the system server and the client apps.;
the client app makes a permanent connection to the server using a main HNP communication connection through a port and tries to keep it alive for the life of the app's process;
the TLS (Transport Layer Security) connection is made over TCP, and after successful connection, TLS is started immediately;
first the server sends its public key (in its server certificate) and client uses it to establish the initial secure connection;
the TLS protocol then does the handshake procedure in which cipher capabilities are negotiated, and a shared secret key is established, and
after that the newly created key is used to secure the following session;
the shared key has an expiration time, and when it expires, it enforces both sides to go through the key creation procedure again.

20. The method of claim 19, wherein
the HNP Authentication & session communication starts after TLS is successfully initiated in response to the initial connection request from the device to the server;
the server responding with a certificate,
creating the secure tunnel, and
starting secure tunnel communications;
the first process is the user authentication,
the user ID, password, and activation key is sent to the server via the secure tunnel;
the server authenticates the user,
checks its activation, and
then responds with user permissions (access privileges) and settings;
the permissions further disables app functions (leaving others as enabled), whereas settings changes the usage behavior;
the HNP session gets started,
then client app on the device sends any requests to execute operation at the server;
if the server has a message for the device, then the same HNP connection is used, and the server pushes the message to the device;
besides receiving messages in this session 500, the client can send requests to: query for contacts, send a message to other contacts, query a sent message status, confirm/reject a message, log out of the session, to which the server can send response;
the HNP Session Lifecycle remains active as long as
the device has some form of data network to stay connected,
the user does not logoff explicitly, and
the client app is kept running (either in background or foreground);
at any time the user can send a logoff request from the device to the server; and
the sever will then terminate the session and secure tunnel.
